(19) United States
(12) Patent Application Publication
(10) Pub. No.: US 2009/0060617 A1
(43) Pub. Date: Mar. 5, 2009

(54) Image forming system, image forming device, and post-processing device

(75) Inventor: Takehiro Ogushi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/998,938

(22) Filed: Dec. 3, 2007

(30) Foreign Application Priority Data
Aug. 28, 2007 (JP) 2007-221207

(51) Int. Cl. G03G 15/00

(52) U.S. Cl. 399/407; 399/405

(57) ABSTRACT

Disclosed is an image forming system comprising: an image forming device; a post-processing device comprising a sheet ejection tray; and an operating section to select either a producing mode for prioritizing a productivity of an image forming or a loading mode for prioritizing a loading accuracy of printing sheets, wherein the producing mode and the loading mode are operation modes for a series of operation from the image forming performed by the image forming device until a loading of the printing sheets for which the image forming is performed, on the sheet ejection tray by the post-processing device.

### BACKGROUND

1. Field of the Invention

The present invention relates to an image forming system, an image forming device, and a post-processing device.

2. Description of Related Art

In an image forming system in which a post-processing device is connected to an image forming device, printing sheets on which an image is formed are post-processed and ejected to a sheet ejection tray. When the printing sheets are ejected, a matching operation can also be performed so that ends of the printing sheets are in alignment.

Conventionally, in order to maintain the productivity in the image forming device, and also to ensure the matching accuracy of the ejected printing sheets, a method is disclosed in which the plurality of printing sheets ejected from the image forming device are overlapped and are ejected to the post-processing device (see for example, Japanese Patent Application Laid-open Publication No. 11-322165, and Japanese Patent Application Laid-open Publication No. 2004-26481). By integrally ejecting a plurality of printing sheets to the post-processing device in this manner, the speed difference of the image forming operation and the matching operation is reduced.

Further, in the case where specialized printing sheets are used, a matching operation modified for the specialized printing sheets is performed. Thus, the matching accuracy is increased, and the productivity of the image forming is increased. Such a method is also disclosed (see for example, Japanese Patent Application Laid-open Publication No. 2007-91468).

As described above, conventionally, a balance between the productivity and the matching property has been considered. However, in accordance with the intention of a user, there may be cases in which the productivity is more emphasized, or in reverse, cases in which the matching accuracy is emphasized. For example, when the user is in a hurry, the user may emphasize the productivity rather than the matching property. Or, when the user has another apparatus, etc. for bookbinding, and sets the printing sheets on which an image is formed as they are to the bookbinding apparatus without the process by the post-processing device, the user may prefer to increase the matching accuracy.

However, the conventional method does not have an operating configuration in which either of the productivity or the matching property is prioritized.

### SUMMARY

According to a first aspect of the present invention, an image forming system comprises:

an image forming device;

a post-processing device comprising a sheet ejection tray; and

an operating section to select either a producing mode for prioritizing a productivity of an image forming or a loading mode for prioritizing a loading accuracy of printing sheets, wherein

the producing mode and the loading mode are operation modes for a series of operation from the image forming performed by the image forming device until a loading of the printing sheets for which the image forming is performed, on the sheet ejection tray by the post-processing device.

According to a second aspect of the present invention, an image forming device comprises:

an image forming section;

a sheet ejection tray; and

an operating section to select either a producing mode for prioritizing a productivity of an image forming or a loading mode for prioritizing a loading accuracy of printing sheets, wherein

the producing mode and the loading mode are operation modes for a series of operation from the image forming performed by the image forming section until a loading of the printing sheets for which the image forming is performed, on the sheet ejection tray.

According to a third aspect of the present invention, a post-processing device comprises:

a sheet ejection tray; and

a control section which corresponds to a producing mode for prioritizing a productivity of an image forming and a loading mode for prioritizing a loading accuracy of printing sheets, wherein

the producing mode and the loading mode are operation modes for a series of operation of a loading of the printing sheets for which the image forming is performed, on the sheet ejection tray.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention and wherein;

FIG. 1 is a diagram showing an image forming system in an embodiment of the present invention;

FIG. 2 is a diagram showing a functional configuration of the image forming system shown in FIG. 1;

FIG. 3 is a top plan diagram showing the configuration of a matching section;

FIG. 4 is a side view diagram showing the configuration of the matching section;

FIG. 5 is an explanatory diagram of a matching operation of matching plates provided in the matching section;

FIG. 6 is an explanatory diagram of an opening operation of the matching plates;

FIG. 7 is an explanatory diagram of a closing operation of the matching plates;

FIG. 8 is an explanatory flow chart of a mode selecting process performed by an image forming device;

FIG. 9 is an explanatory flow chart of a condition setting process performed by the image forming device;

FIG. 10 is en explanatory flow chart of a feeding process performed by the image forming device;

FIG. 11 is an explanatory flow chart of an overlapping determining process performed by the image forming device;

FIG. 12 is an explanatory flow chart of a process performed by an intermediate conveying device;

FIG. 13 is an explanatory flow chart of a process performed by a post-processing device;

FIG. 14 is a time chart showing the matching operation in the matching section in a producing mode; and

FIG. 15 is a time chart showing the matching operation in the matching section in a loading mode.

### DESCRIPTION OF THE PREFERRED EMBODIMENT

Hereinbelow, an embodiment of the present invention concerning the image forming system, image forming device, and the post-processing device is explained with reference to the drawings.

First, the configuration is explained.

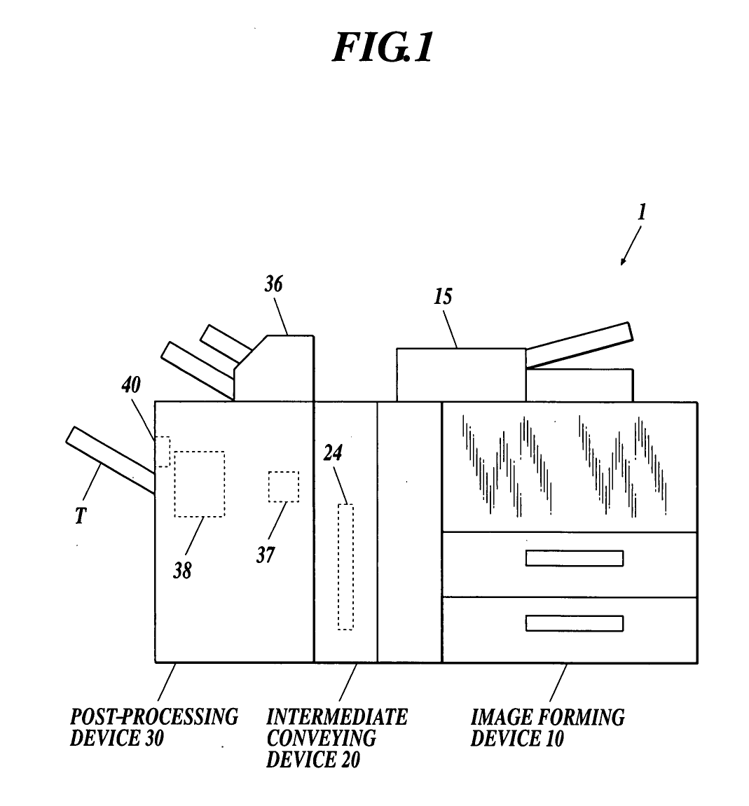

As shown in FIG. 1, the image forming system 1 comprises an image forming device 10, an intermediate conveying device 20, and a post-processing device 30.

The image forming system 1 forms an image on printing sheets by the image forming device 10. Then, a post-process such as a punching process, etc. is performed by the post-processing device 30 on the printing sheets on which the image has been formed. Thus, the printing sheets are ejected to a sheet ejection tray T. The intermediate conveying device 20 is provided in between the image forming device 10 and the post-processing device 30. The intermediate conveying device 20 mediates the conveying of the printing sheets and adjusts the speed difference of the image forming and the post-process. In the intermediate conveying device 20 and the post-processing device 30, a conveying passage (a path) of the printing sheets ejected from the image forming device 10 is formed.

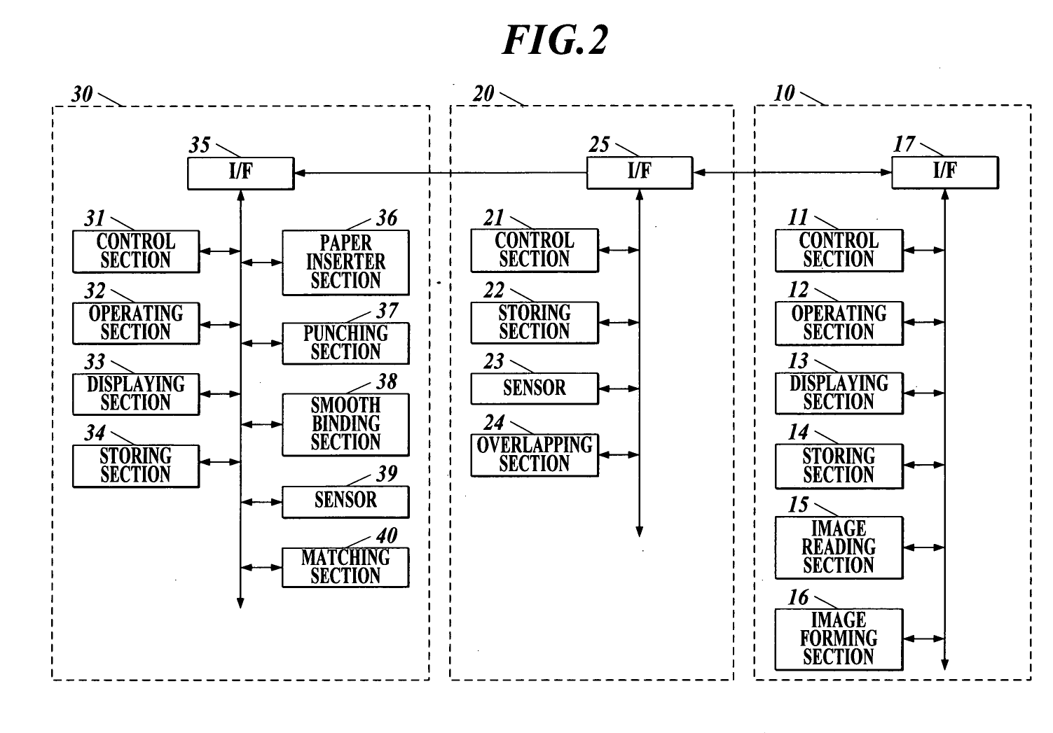

With reference to FIG. 2, each device is explained. FIG. 2 is a diagram showing a functional configuration of each device.

As shown in FIG. 2, the image forming device 10 comprises a control section 11, an operating section 12, a displaying section 13, a storing section 14, an image reading section 15, and an image forming section 16.

The control section 11 comprises a CPU (Central Processing Unit), RAM (Random Access Memory), etc. The control section 11 performs various operations by collaboration with a control program which is stored in the storing section 14 to control the operations of each section, such as the image forming operation.

Incidentally, the control section 11 is linked with control sections 21 and 31 of the intermediate conveying device 20 and of the post-processing device 30 respectively, by sending and receiving a control signal through I/Fs 17, 25 and 35. The control section 11 integrally controls not only the image forming device 10, but also the conveying operation in the intermediate conveying device 20, and the post-processing operation, the matching operation in the post-processing device 30.

The operating section 12 comprises a touch panel, etc. which is integrally comprised by operation keys and the displaying section 13. A setting operation of various image forming conditions, post-processing conditions is possible through the operating section 12. The operating section 12 generates an operation signal appropriate for the operation of the operation keys, etc. to output the operation signal to the control section 11.

The displaying section 13 comprises a display, and displays the operation screen of the setting screens, etc. concerning the image forming or the post-process according to the displaying control of the control section 11.

The storing section 14 comprises a large-capacity memory, etc. and stores the control program, a parameter, etc.

The image reading section 15 comprises an ADF (Auto Document Feeder), a scanner, etc. The image reading section 15 reads the image of a document, and performs a process of generating a data of the image.

The image forming section 16 forms an image on the printing sheets based on the data of the image input from the control section 11. Any image forming method can be used in the image forming section 16. Here, a case in which an electrographic method is used is explained as an example. In a case of the electrographic method, the image forming section 16 comprises a feeding section, an exposing section, a transfer belt, an image developing section, a photographic fixing section, etc. The image forming section 16 performs an exposing by irradiating a laser beam on a photoconductive drum from a laser light source of the exposing section to form an electrostatic latent image. Then, a toner image is generated by spraying toners to the photoconductive drum by the image developing section. The image forming section 16 performs the image forming by transferring the toner image to the printing sheets conveyed from the feeding section.

The printing sheets on which the image is formed are conveyed to the intermediate conveying device 20 by a conveying section (not shown).

The I/F 17 is an interface which is connected to the I/F 25 of the intermediate conveying device 20. The I/F 17 performs an input and an output of the control signal, etc. which interacts between the intermediate conveying device 20 or the post-processing device 30 and the image forming device 10.

Next, the intermediate conveying device 20 is explained.

As shown in FIG. 2, the intermediate conveying device 20 comprises a control section 21, a storing section 22, a sensor 23, an overlapping section 24, the I/F 25, etc.

The basic configuration of the control section 21 is the same as that of the control section 11 in the image forming device 10. The control section 21 controls the conveying operation of the printing sheets including the overlapping of the printing sheets in the overlapping section 24 according to the control signal from the control section 11.

The storing section 22 stores the control program performed in the control section 21, the parameter, etc.

The sensor 23 is a light sensor, etc. provided near the entrance of the overlapping section 24. The sensor 23 detects the printing sheets conveyed to the overlapping section 24. The detecting result of the sensor 23 is output to the control section 21.

The overlapping section 24 is configured so that the printing sheets conveyed from the image forming device 10 can be conveyed to the post-processing device 30 in a state of being two-ply overlapped printing sheets simultaneously. That is to say, by performing the overlapping of the printing sheets in the overlapping section 24, the conveying time of the printing sheets to the post-processing device 30 is adjusted. Further, the speed difference between the image forming in the upstream side in which the processing speed is fast, and the post-process in the downstream side in which the speed thereof is slower than that of the image forming, is adjusted.

The overlapping section 24 is capable of the normal conveying operation in which printing sheets are conveyed one sheet each, and of the conveying operation in which two-ply overlapped printing sheets are conveyed. In the case of the normal conveying operation, the printing sheets conveyed from the image forming device 10 are sequentially conveyed through the path conveying to the post-processing device 30. On the other hand, a buffer-roller is provided on the path in the overlapping section 24. In the case where two-ply overlapped printing sheets are conveyed, the precedent printing sheet is conveyed not to the normal path but to the buffer-roller, and the buffer-roller is revolved. Thus, the printing sheet is wound around the buffer-roller. Then, the following printing sheet is conveyed to the normal path, and when the following printing sheet reaches the position of the overlapping, the buffer-roller is revolved. Thus, the precedent printing sheet is conveyed on top of the following printing sheet and is overlapped. The two printing sheets of the precedent and the following which are overlapped, are conveyed to the post-processing device 30 through the path.

Next, the post-processing device 30 is explained.

As shown in FIG. 2, the post-processing device 30 comprises the control section 31, an operating section 32, a displaying section 33, a storing section 34, the I/F 35, a paper inserter section 36, a punching section 37, a smooth binding section 38, a sensor 39, and a matching section 40.

The basic configuration of the control section 31 is the same as that of the control section 11 in the image forming device 10. The control section 31 controls the post-processing operation by the punching section 37, etc., the matching operation by the matching section 40, and the like according to the control signal from the control section 11.

The operating section 32 comprises the operation keys, etc. to perform a setting operation of the post-processing. The operating section 32 generates the operation signal appropriate for the operation, and outputs the operation signal to the control section 31. When a setting for the post-process is done at the same time as a setting for the image forming per one job in the operating section 12 of the image forming device 10, the post-processing device 30 performs the post-process in the series of operation of the job. However, the post-processing device 30 can also perform only the post-process in a state of being separate from the image forming. In this case, a setting operation of the post-process is possible through the operating section 32.

The displaying section 33 comprises a display, and displays an operation screen, etc. regarding the post-process.

The storing section 34 stores the control program, the parameter, etc. performed in the control section 31.

When a specialized printing sheet such as tab paper, etc. is inserted for performing the job, or when only the post-process is performed in a state of being separate from the image forming job, the paper inserter section 36 inserts the printing sheets in order that the post-process is performed. The paper inserter section 36 comprises a feeding tray, and conveys the printing sheets set to the feeding tray to the path for the printing sheets inside the post-processing device 30. Then, the printing sheets are conveyed to the punching section 37 and the smooth binding section 38 by the conveying section (not shown).

The punching section 37 and the smooth binding section 38 are provided on the path, and perform the post-process to the printing sheets conveyed through the path according to the control of the control section 31. The punching section 37 performs a punching process in which a punch hole is provided on the printing sheets. The smooth binding section 38 performs a smooth binding process in which a smooth binding is performed to the printing sheets. The printing sheets on which the post-process is performed are further conveyed and ejected to the sheet ejection tray T. Incidentally, in the case where the setting is that only the image forming is performed and the post-process is not performed, the printing sheets pass through the punching section 37 and the smooth binding section 38, and are ejected to the sheet ejection tray T as it is without receiving the post-process.

The sensor 39 is a light sensor, etc. provided near the ejecting port to the sheet ejection tray T. The sensor 39 detects the printing sheets ejected to the sheet ejection tray T, and outputs the detected information to the control section 31.

The matching section 40 performs the matching of the printing sheets ejected to the sheet ejection tray T.

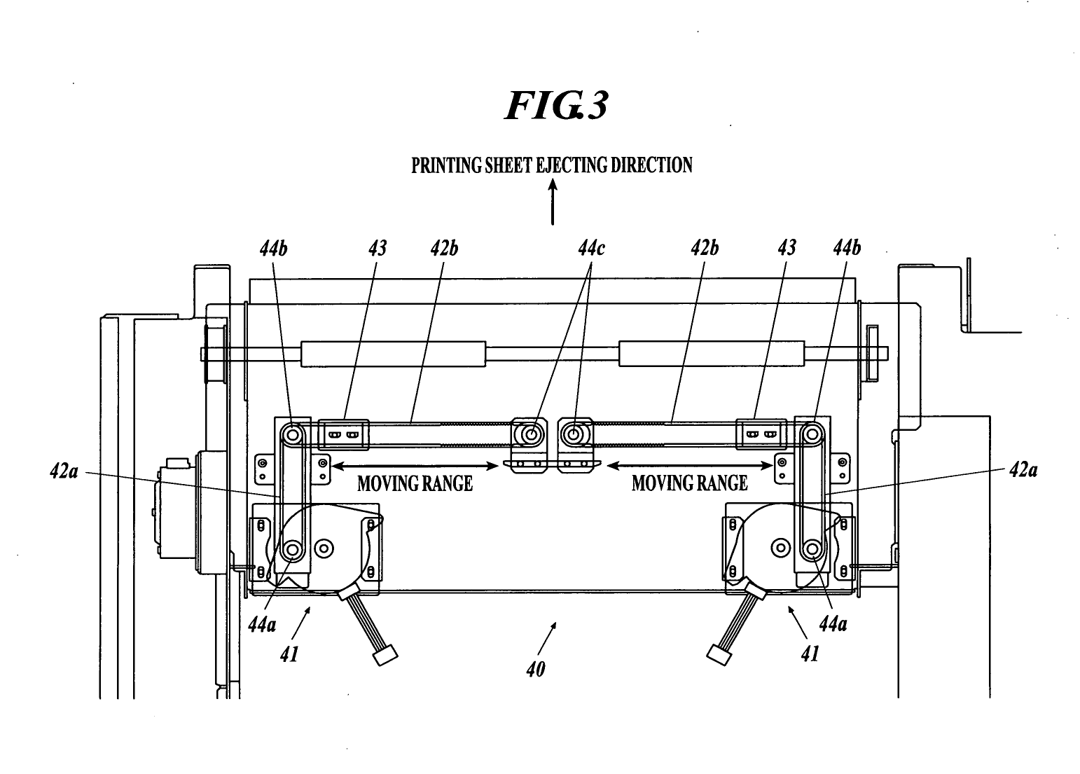

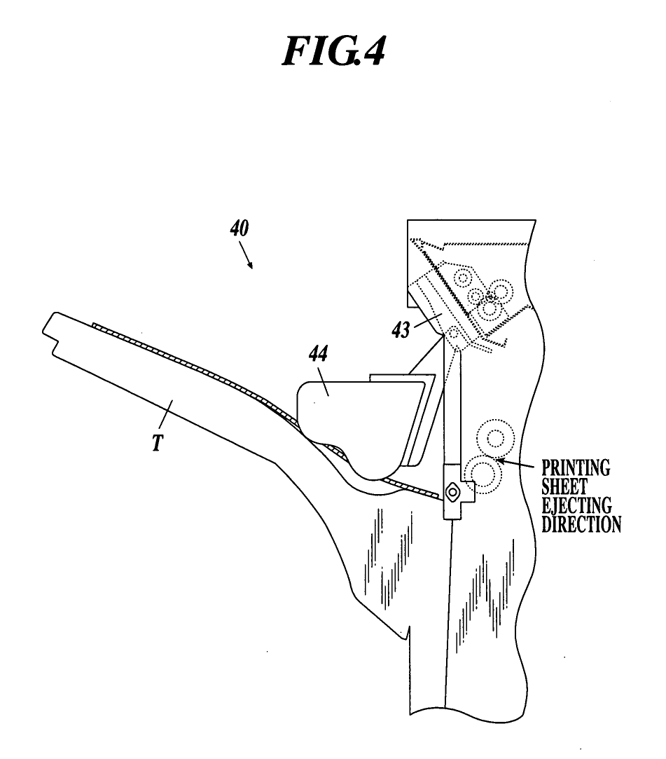

FIG. 3 is a top plan diagram of the matching section 40, and FIG. 4 is a side view diagram thereof.

As shown in FIGS. 3 and 4, the matching section 40 has one pair of matching plates 44, and moves the matching plates 44 so that the matching plates 44 sandwich the printing sheets ejected to the sheet ejection tray T from the right and left sides. Thus, the matching section 40 performs the matching of the printing sheet edges in the direction perpendicular to the direction in which the printing sheets are conveyed (hereinafter referred to as a horizontal direction). Incidentally, because the sheet ejection tray T has an inclination (see FIG. 4), the posterior edges of the printing sheets ejected to the sheet ejection tray T are returned to the ejecting port side by the inclination. Thus, the printing sheets contact the main body of the image forming device 10. Therefore, the matching in the direction in which the printing sheets are conveyed is performed.

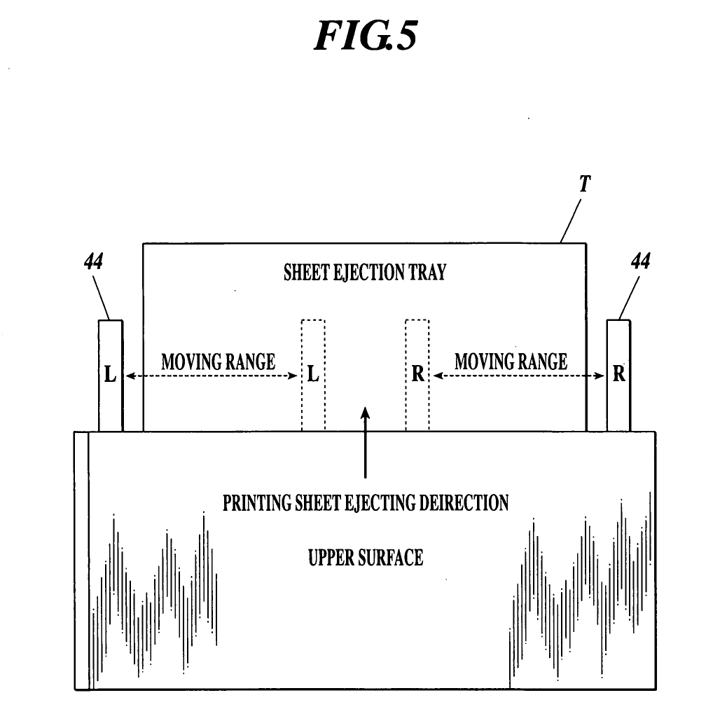

As shown in FIGS. 3 and 4, the matching plates 44 are attached to an attaching member 43 provided on a drive transmission belt 42b. A drive transmission belt 42a is wound around one pair of revolving shaft 44a and 44b, and the drive transmission belt 42b is wound around revolving shaft 44b and 44c. The revolving shaft 44a revolves by the driving of a driving section 41, the drive transmission belt 42a is revolved, and thus the revolving shaft 44b is revolved. As a result, the drive transmission belt 42b is revolved, and the attaching member 32 provided on the drive transmission belt 42b can be moved in the horizontal direction. That is to say, when the drive transmission belt 42b is moved, the matching plates 44 attached to the attaching member 43 are moved within a certain range in the horizontal direction, as shown in FIG. 5.

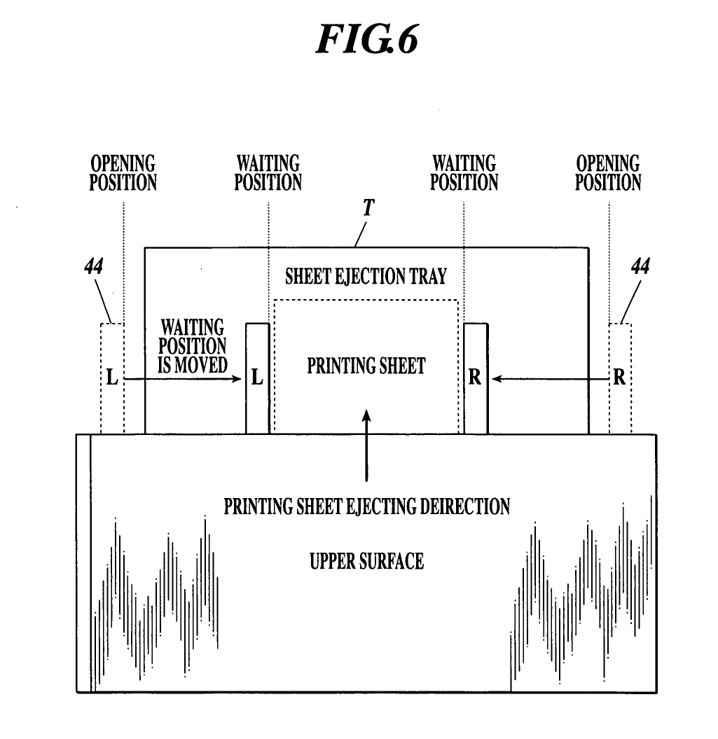

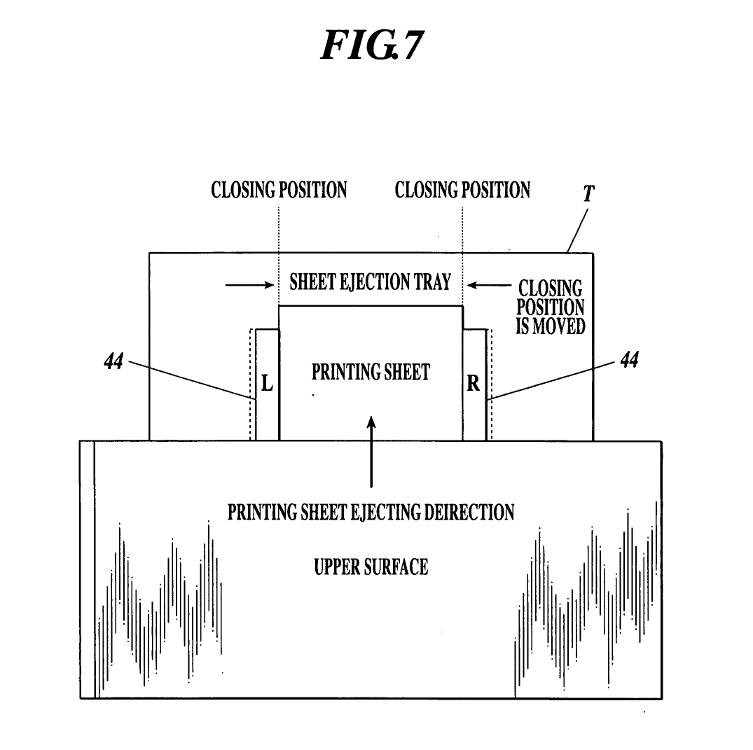

The matching operation is explained with reference to FIGS. 6 and 7. FIGS. 6 and 7 are top plan diagrams of the post-processing device 30.

Before an image is formed, the matching plates 44 are positioned at an opening position shown in FIG. 6. When a control signal that the image forming is started is received from the image forming device 10, the matching plates 44 are moved from the opening position to a waiting position by the control of the control section 31 as shown in FIG. 6. The waiting position is a position in which a spaced portion is slightly provided from the printing sheet. The waiting position is calculated by the control section 31 which has received the information of the printing sheets used for the image forming from the image forming device 10. The waiting position is calculated in view of a width and an ejecting position of the printing sheets in the horizontal direction.

Next, when the printing sheets are actually ejected to the sheet ejection tray T, the starting of the ejection is detected by the sensor 39. Then the matching section 40 performs the closing operation in which the matching plates 44 are closed at a timing instructed by the control section 31. Subsequently, the opening operation of the matching plates is performed and the matching plates are returned to the waiting position after a certain amount of time. The closing and opening operations are repeated to each of the ejected printing sheets. After the closing operation to the last printing sheet is performed, the matching plates 44 are returned to the opening position. Here, when the closing operation is performed by the matching plates 44, a pair of the matching plates 44 is moved toward the closing position so as to sandwich the printing sheet. In reverse, when the opening operation is performed by the matching plates 44, each of the plates are moved respectively towards the waiting positions located in the left edge side and the right edge side in the horizontal direction. By the matching operation, the right and left edges of the printing sheets can be matched.

Next, the operation of the image forming system 1 is explained.

The image forming system 1 comprises a producing mode in which the productivity is prioritized and a loading mode in which the matching property of the printing sheets when loaded to the sheet ejection tray T is prioritized, as a series of operation mode from the image forming to the post-process. The user can set either of the operation modes. The setting is performed in the image forming device 10.

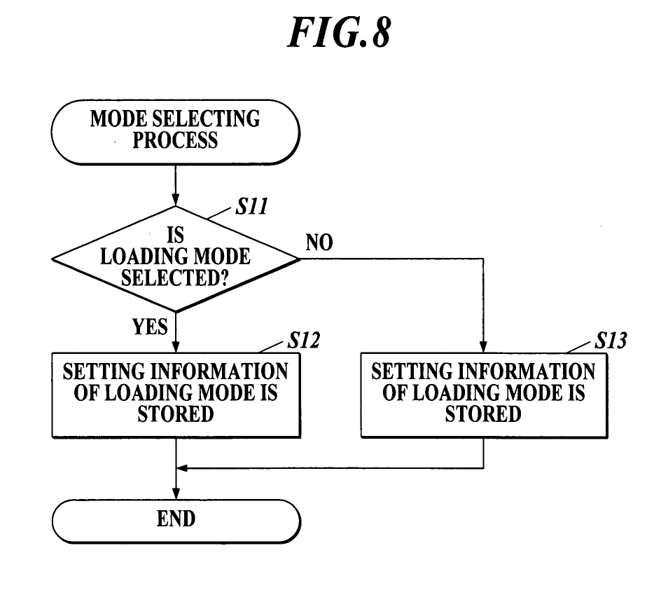

Hereinbelow, a mode process performed by the image forming device 10 at the setting is explained with reference to FIG. 8.

First, a setting screen for selecting the producing mode or the loading mode is displayed on the displaying section 13 by the control of the control section 11. When the loading mode is selectively operated through the operating section 12 in the setting screen (step S11; Y), the control section 11 instructs the storing section 14 to store the setting information of the loading mode (step S12). On the other hand, when not the loading mode but the producing mode is selected (step S11; N), the control section 11 instructs the storing section 14 to store the setting information of the producing mode (step S13), and ends the process. Incidentally, there may be a configuration in which the producing mode is preliminarily set as a default, and the loading mode is selected only when the matching property is emphasized rather than the productivity.

Subsequently, the setting of the job is performed. That is to say, conditions regarding the image forming such as the number of image forming copies, a sheet size, a sheet type, etc., and conditions regarding the post-process such as the number of punch holes in the punching process, a binding method in the smooth binding process, etc. are input by an input operation of a user. Then, the control section 11 instructs the storing section 14 to store these conditions as the setting information of the job. Thus, a document on which an image is formed is read by the image reading section 15, and the performing of the job is started.

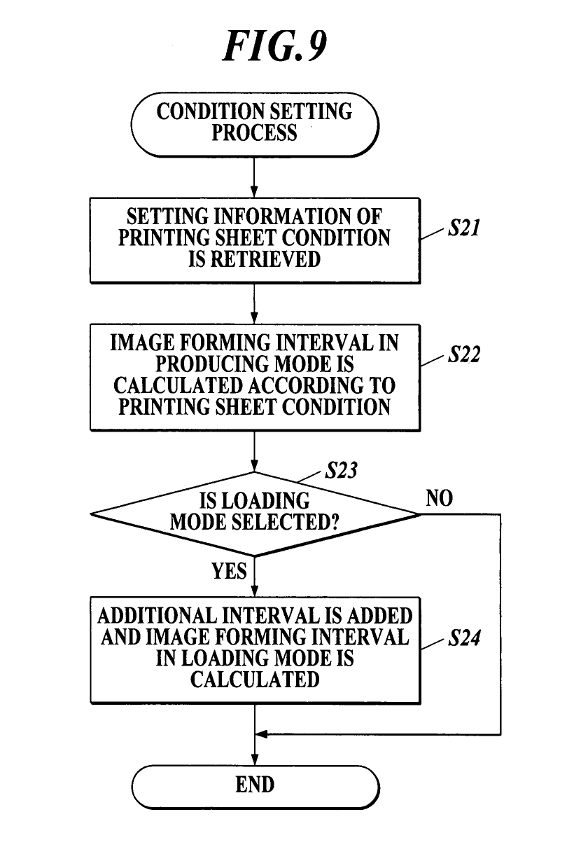

The image forming device 10 first performs the condition setting process shown in FIG. 9. The condition setting process is a process in which a performing condition of the job is set according to the operation mode selected from either the producing mode or the loading model.

As shown in FIG. 9, the control section 11 retrieves the sheet size condition from the setting information of the job stored in the storing section 14 (step S21). The sheet size condition is a condition which is set regarding the printing sheet, such as the sheet size and sheet type, etc. used for an image forming. Then, an interval for performing the image forming (a unit of time for forming an image once) is calculated according to the condition of the printing sheets (step S22). Here, the calculated image forming interval is the interval in which the fastest image forming is possible under the set condition of the printing sheets. The calculated image forming interval is the image forming interval in the producing mode.

Next, the control section 11 refers to the setting information of the operation mode, and determines whether the loading mode is set (step S23). When the loading mode is set (step S23; Y), an additional interval of the image forming interval is calculated. Then, the additional interval is added to the calculated image forming interval in the producing mode so that the image forming interval in the state of the loading mode is calculated (step S24). By adding the additional interval, the time used for the matching operation at the loading is extended, and more accurate matching operation is possible.

The setting information in the loading mode is output to the control section 31 of the post-processing device 30 from the control section 11 with the setting information of the job, as the control information of the matching operation of the printing sheets in the post-processing device 30.

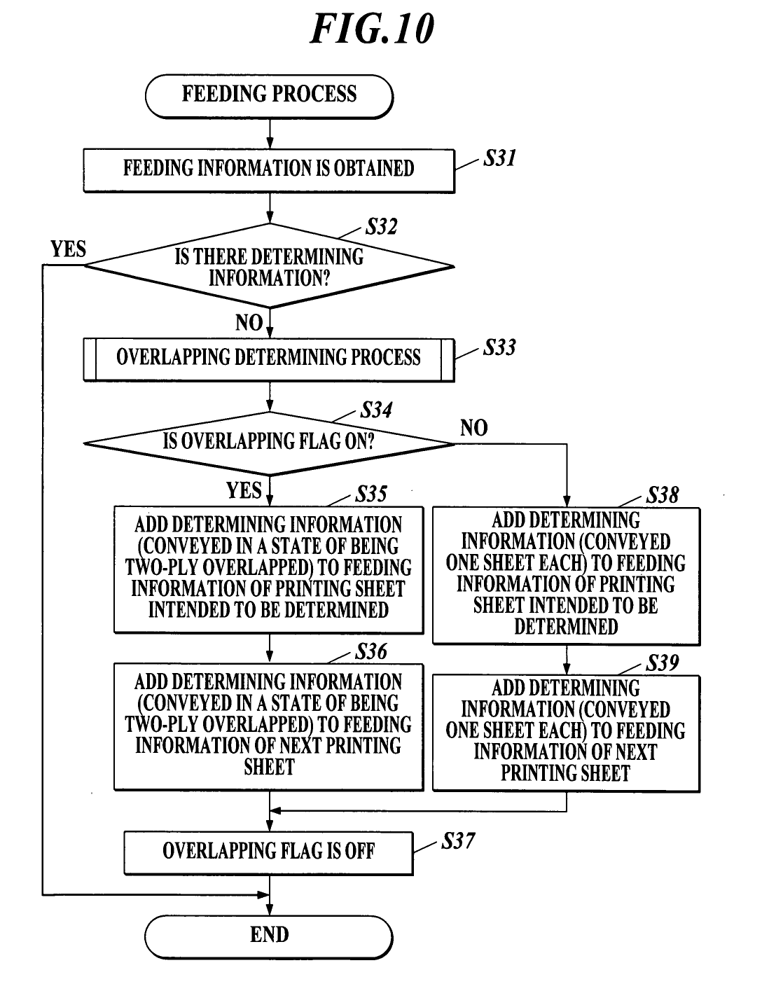

Next, the control section 11 performs a feeding process shown in FIG. 10.

Even after the image formed printing sheets are ejected to the intermediate conveying device 20, in order to control the conveying operation of the printing sheets in the intermediate conveying device 20, the control section 11 generates feeding information to each of the printing sheets used for the image forming. The feeding information is control information which instructs the intermediate conveying device 20 to convey the printing sheets in a state of either one sheet each or two-ply sheets. The feeding information is output to the intermediate conveying device 20 at the same time when the printing sheets are ejected to the intermediate conveying device 20. The feeding process is a process in which the feeding information is set. Incidentally, the feeding process shown in FIG. 10 is repeated per one sheet for the entire printing sheets on which the image forming is performed.

As shown in FIG. 10, the control section 11 obtains the feeding information of one printing sheet which is to be performed with the image forming (step S31). Incidentally, in the subsequent process, the feeding information is set per two-ply continuous printing sheets. Thus, in the case of the following printing sheet of the two-ply continuous printing sheets, the feeding information thereof is already set when the process of the precedent printing sheet is performed. In such a case, the feeding information which is already set is retrieved. On the other hand, during the job, the feeding information of the first printing sheet, etc. is not yet set. In such a case, the control section 11 newly generates and sets feeding information. The feeding information includes, for example, information to specify the printing sheets such as, for which job is the printing sheet used, how many printing sheets has it been conveyed, etc. Further, the feeding information includes determining information. The determining information is control information which is used when determining whether to convey the printing sheets in a state of being either one sheet each or two-ply sheets in the intermediate conveying device 20. The determining information is set by the later described process.

Next, the control section 11 determines whether the determining information is already set in the obtained feeding information (step S32). When the determining information is included in the feeding information, and is already set (step S32; Y), the process is ended.

On the other hand, when it is determined that the determining information is not included in the feeding information, and is not yet set (step S32; N), it is migrated to an overlapping determining process in step S33.

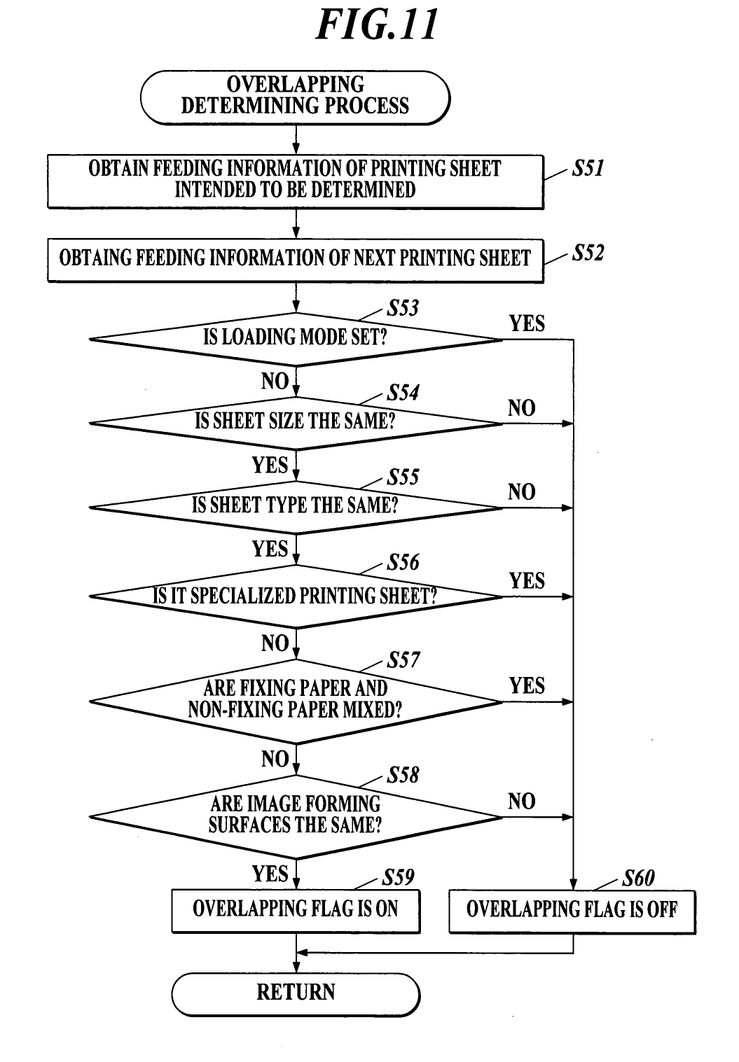

The overlapping determining process is explained with reference to FIG. 11.

As shown in FIG. 11, the control section 11 obtains the feeding information of the printing sheets intended to be determined in the overlapping determining process (step S51). Further, the control section 11 obtains the feeding information of the next printing sheet intended to be determined (the following printing sheet) (step S52).

Next, the control section 11 refers to the setting information of the operation mode, and determines whether the loading mode is set (step S53). When the loading mode is set (step S53; Y), in order to perform the loading accurately, the two-ply overlapping is not performed. Thus, the control section 11 provides an overlapping flag for the printing sheet and the next printing sheet intended to be determined. The control section 11 sets the overlapping flag to “OFF” indicating that the two-ply overlapping is not performed (step S60). Incidentally, the overlapping flag is information stored in RAM, etc. in the control section 11 for the entire printing sheets. On the other hand, in the case where not the loading mode but the producing mode is set (step S53; N), the control section 11 refers to the setting information of the printing sheet condition, and determines whether the sizes of the printing sheet and the next printing sheet intended to be determined are the same (step S54).

When the sizes are not the same (step S54; N), the two-ply overlapping cannot be performed. Thus, the control section 11 determines that the two-ply overlapping is not performed in this case and sets the overlapping flag to “OFF” (step S60).

On the other hand, even when the sizes are the same (step S54; Y), but when the types of the printing sheets are not the same (step S54; N), the two-ply overlapping cannot be performed. Thus, the control section 11 determines that the two-ply overlapping is not performed and sets the overlapping flag to “OFF” (step S60).

When the types of the printing sheets are the same (step S55; Y), the control section 11 refers to the setting information of the conditions of the printing sheets and the post-process. Then the control section 11 determines whether either of the printing sheet or the next printing sheet intended to be determined is a specialized printing sheet (step S56). In a case where either one of them is a specialized printing sheet such as tab paper, etc. (step S56; Y), the two-ply overlapping cannot be performed and the control section 11 sets the overlapping flag to “OFF” (step S60). On the other hand, in a case where either of them is not a specialized printing sheet, but where fixing paper and non-fixing paper are mixed (step S57; Y), the control section 11 sets the overlapping flag to “OFF” in the same manner (step S60).

When fixing paper and non-fixing paper are not mixed (step S57; N), the control section 11 determines whether the image forming surfaces are the same (step S58). When the image forming surfaces are not the same (step S58; N), the control section 11 sets the overlapping flag to “OFF” (step S60). When the image forming surfaces are the same (step S58; Y), the control section 11 sets the overlapping flag to “ON” which indicates that the two-ply overlapping is performed (step S59).

As described above, when the overlapping flag is set to either “ON” or “OFF”, the overlapping determining process is ended, and it is migrated to a process in step S34 shown in FIG. 10.

In step S34 shown in FIG. 10, the control section 11 refers to the overlapping flag, and determines whether it is set to “ON” (step S34). When it is set to “ON” (step S34; Y), the control section 11 sets the determining information to the feeding information of the printing sheets intended to be determined, so that it is instructed that when the printing sheets are conveyed, the two-ply overlapping with the following printing sheet is performed (step S35). Subsequently, the control section 11 sets the determining information to the feeding information of the next printing sheet, so that it is instructed that when conveying, the two-ply overlapping with the precedent printing sheet is performed (step S36).

On the other hand, when the overlapping flag is set to “OFF” (step S34; N), the control section 11 sets the determining information to the feeding information of the printing sheets intended to be determined (the feeding information obtained in the overlapping determining process in step S51), so that it is instructed that the conveying is performed in a state of being one sheet each (step S38). Subsequently, the control section 11 sets the determining information to the feeding information of the next printing sheet (the feeding information obtained in the overlapping determining process in step S52), so that it is instructed that the conveying is performed in a state of being one sheet each (step S39).

When the determining information is set respectively, the overlapping flag is reset to “OFF” (step S37), and the process is ended.

As described above, when the setting of the feeding information is ended, the control section 11 instructs the image forming section 16 to start image forming. During this process, the image forming is performed by the image forming interval which is set in the condition setting process (see FIG. 9) according to the operation mode. When the image forming is ended, the control section 11 ejects the image formed printing sheet to the intermediate conveying device 20 through the conveying section (not shown). At the same time of the ejection, the control section 11 outputs the feeding information of the ejected printing sheet to the intermediate conveying device 20.

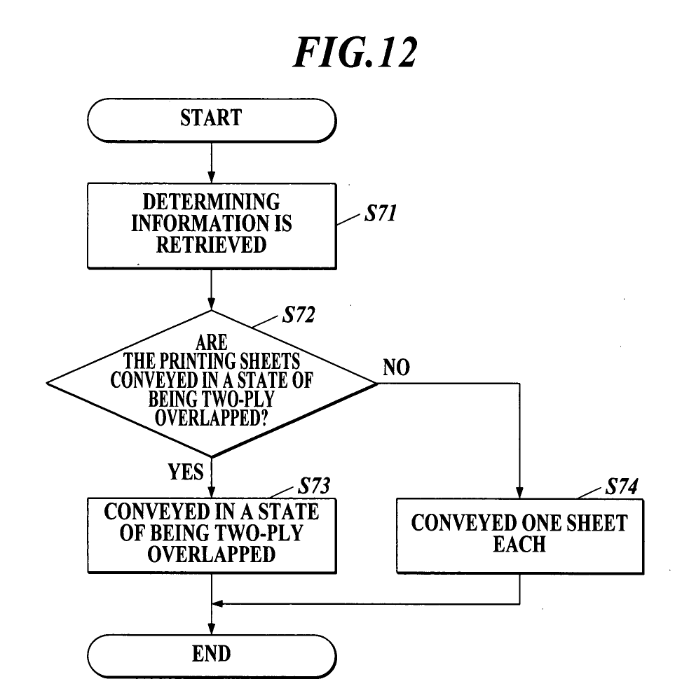

In the intermediate conveying device 20, when the printing sheets are conveyed from the image forming device 10, a conveying control process shown in FIG. 12 is performed. The conveying control process is a process for controlling the overlapping of the conveyed printing sheets. The conveying control process is performed for each printing sheet when conveyed.

As shown in FIG. 12, the control section 21 refers to the feeding information of the printing sheets input through the I/F 25 when the printing sheets are conveyed. Then the control section 21 retrieves the determining information included in the feeding information (step S71). Thus, based on the determining information, the control section 21 determines whether it is instructed that the printing sheets are conveyed in a state of being two-ply overlapping (step S72).

In a case where the determining information is that the conveying in a state of being two-ply overlapped is instructed (step S72; Y), the control section 11 controls the conveying operation of the printing sheets by the overlapping section 24. Thus, the conveying is performed in a state of being two-ply overlapped with the following printing sheet instructed to be performed with the two-ply overlapping. The overlapping section 24 conveys the precedent printing sheet instructed to be performed with the two-ply overlapping to the two-ply overlapping path, and conveys the following printing sheet to the normal path, according to the control of the control section 21. Thus, two-ply overlapping is performed at the overlapping position, and the printing sheets are ejected to the post-processing device 30 as they are (step S73).

Alternatively, in a case where the determining information is that the conveying in a state of being one sheet each is instructed (step S72; N), the control section 11 controls the conveying operation of the printing sheets by the overlapping section 24, so that the printing sheets are conveyed in a state of being one sheet each. The overlapping section 24 conveys the instructed printing sheets to the normal path, and ejects the printing sheets to the post-processing device 30 per one sheet, according to the control of the control section 21 (step S74).

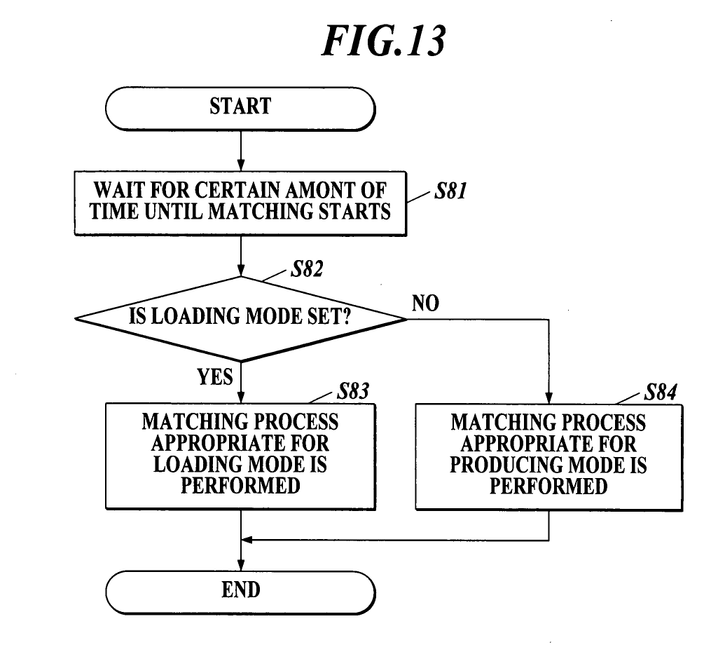

On the other hand, in the post-processing device 30, based on the post-processing condition included in the setting information of the job which is input from the image forming device 10, the punching section 37, etc. perform the post-process to the printing sheets conveyed from the intermediate conveying device 20. The printing sheets on which the post-process is performed are conveyed to the sheet ejection tray T through the conveying section (not shown) by the control of the control section 31. The ejecting process performed during this process is explained with reference to FIG. 13.

As shown in FIG. 13, when the printing sheets ejected to the sheet ejection tray T are detected by the sensor 39, the control section 31 waits for a certain amount of time until the matching starts (step S81). Then, when the certain amount of time passes, the control section 31 determines whether the loading mode is set (step S82). When the loading mode is set (step S82; Y), the control section 31 instructs the matching section 40 to perform the matching process appropriate for the loading mode (step S83). When the producing mode is set (step S82; N), the control section 31 instructs the matching section 40 to perform the matching process appropriate for the producing mode (step S84).

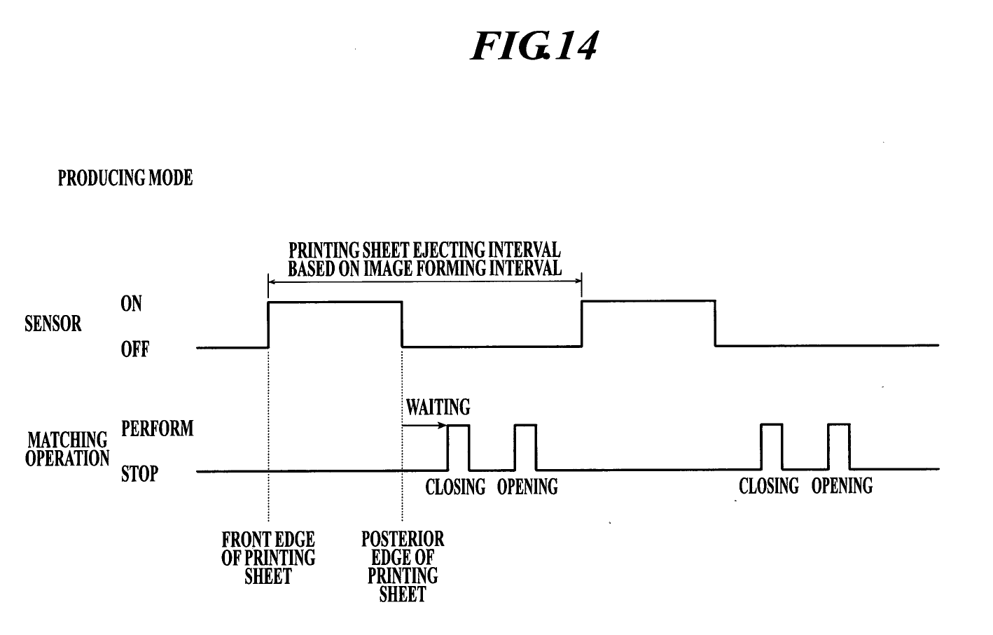

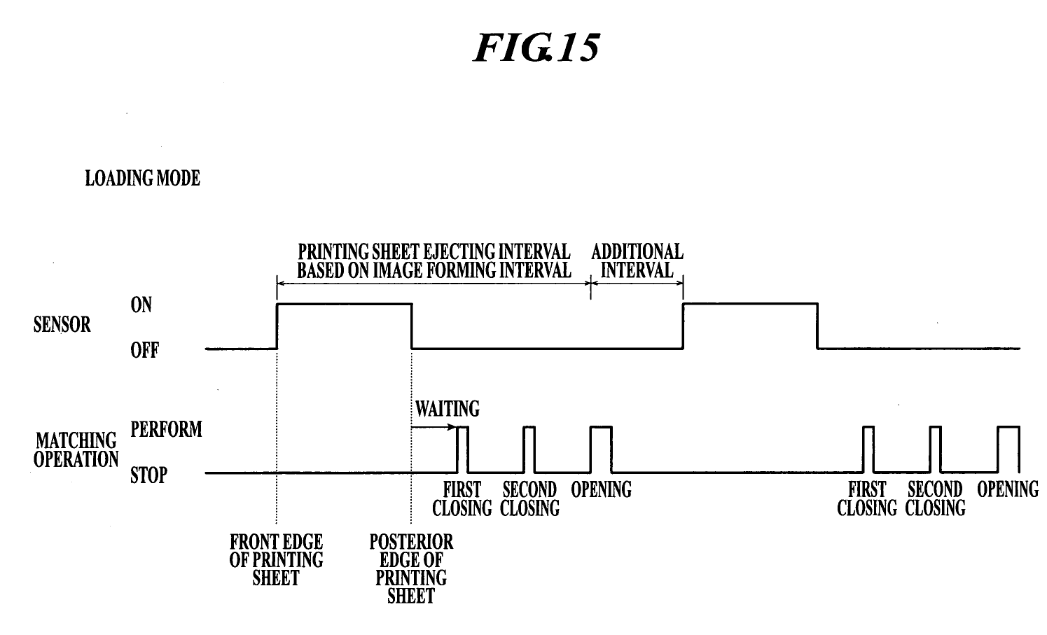

The matching processes appropriate for each mode are explained with reference to FIGS. 14 and 15.

FIGS. 14 and 15 are timing charts showing the matching operations of the matching section 40. FIG. 14 shows the case in the producing mode, and FIG. 15 shows the case in the loading mode.

In the post-processing device 30, the setting information of the loading mode, which is set in the image forming device 10 is input. As a result, as shown in FIGS. 14 and 15, the printing sheets are ejected to the sheet ejection tray T in a sheet ejecting interval based on the image forming interval which is set in the condition setting process (see FIG. 9). The sheet ejecting interval in the loading mode is longer than the sheet ejecting interval in the producing mode by the additional interval, and the matching time is longer.

In the producing mode, as shown in FIG. 14, the edges of the printing sheets are detected by the sensor 39, the printing sheets are completely ejected, the posterior edges are detected, and the post-processing device 30 waits for a certain amount of time. Then, the matching plates 44 perform a closing operation once according to the control of the control section 31. The waiting for a certain amount of time until the closing operation is for the ejected printing sheets to stabilize on the sheet ejection tray T. After the closing operation, when a certain amount of time additionally passes, the matching plates 44 perform an opening operation. This process is repeated every time the printing sheets are ejected.

In the loading mode, as shown in FIG. 15, the process is performed in the same manner as that in the producing mode until the waiting for a certain amount of time after when the posterior edges of the printing sheets are detected by the sensor 39. However the process in the loading mode is different form that in the producing mode in that the closing operation is performed twice. Further, the moving distance of the matching plates 44 in each closing operation is shorter than that in the closing operation in the producing mode. That is to say, in the loading mode, the matching plates 44 are not moved to the eventual closing position by the first closing operation, and they are stopped in from of the eventual closing position. Then, the matching plates 44 are moved to the eventual closing position by the second closing operation. After a certain amount of time passes from the second closing operation, the opening operation is performed. This process is repeated every time the printing sheets are ejected.

In this manner, in the loading mode, the printing sheets are stabilized by the first closing operation, and then the second closing operation is performed. Thus, the loading mode has a configuration in which neater and more accurate matching operation can be performed compared to the producing mode.

As described above, according to the embodiment, the setting information of the operation mode which is selectively operated by the user from either the producing mode or the loading mode is stored. The operation control such as the image forming, etc. is performed according to the operation mode. Thus, the user can operate the device by prioritizing either the productivity or the matching property in accordance with the intention of the user.

The operation control controls the image forming operation such as the image forming interval in the image forming device 10, etc.

Thus, in the producing mode in which the productivity is prioritized, the image forming interval is set so that the image forming can be performed in the highest speed. Thus a number of image forming can be performed in a shorter time than in the loading mode, and the productivity is increased. Further, in the loading mode in which the loading accuracy is prioritized, the image forming interval is made longer than in the producing mode by adding additional intervals to the image forming interval. Thus, the interval of ejecting the printing sheets are extended in the post-processing device 30, the matching time can be ensured, and the matching can be performed with a high accuracy.

Further, the operation control controls the conveying operation such as overlapping the printing sheets or not in the intermediate conveying device 20, etc.

That is to say, in the producing mode, the printing sheets are conveyed in a two-ply overlapping so that the image forming is possible in a high speed. In the loading mode, the printing sheets are conveyed not in a two-ply overlapping but in one sheet each so that the accuracy can be increased when matching.

Further, the operation control controls the matching operation such as the matching time, the number of times of matching of the printing sheets, and the position of the matching plates 44 in the post-processing device 30, etc.

That is to say, in the producing mode, the time required for the matching can be shortened by performing the closing operation once during the printing sheet ejecting interval. Thus, it can be configured so that the productivity of the image forming is increased. On the other hand, in the loading mode, the printing sheet ejecting interval is longer than in the producing mode, and the matching is performed for a long time. During the matching, the closing operation is performed twice. In the closing operation, the position of the matching plates 44 is not moved to the closing position at once, but is moved thereto by performing the closing operation twice. Alternatively, the number of the matching may be set the same as that in the producing mode, and the time after the closing operation until the opening operation may be made longer. By this neat matching operation, the matching accuracy of the printing sheets can be increased.

As described above, by controlling the series of operation from the image forming to the loading of the printing sheets on the sheet ejection tray T, the productivity is increased in the producing mode, and the matching accuracy of the printing sheets is increased in the loading mode. As a result, the user can prioritize the productivity by selecting the producing mode, or the user can prioritize the matching accuracy by selecting the loading mode, when performing the series of operation.

Incidentally, the above described embodiment is a preferred example of the present invention, and the present invention is not limited to this.

For example, in the above described embodiment, the image forming operation in the image forming device 10, the conveying operation in the intermediate conveying device 20, and the matching operation in the post-processing device 30 are all controlled. However, a combination of either one or two of them may be controlled.

Further, it is not limited to execution/non-execution of the two-ply overlapping of the printing sheets performed in accordance with the operation mode in the intermediate conveying device 20. The number of sheets for overlapping may be changed, the conveying speed may be switched, or the combination thereof may be applied.

Alternatively, in accordance with the configuration system, the intermediate conveying device 20 may not intervene. In this case, only the image forming image forming operation device 10 and the matching operation of the post-processing device 30 are controlled in accordance with the set operation mode so that the productivity and the matching property are adjusted.

Further, in the above explanation, the image forming system 1 is described. However, a case in which the image forming device 10 or the post-processing device 30 is of a single body can be applied to the present invention.

For example, even in a case of the image forming device 10 single body, when the matching section is provided in the sheet ejection tray of the image forming device 10, the matching operation of the matching section is controlled by the control section 11 in accordance with the set operation mode. Thus, the same effect as that of the above described embodiment can be obtained.

Further, the configuration in which the operation mode is selectively set through the operating section 12 of the image forming device 10 was explained. However, the operation mode may be selectively set through the operating section 32 of the post-processing device 30.

According to one aspect of the preferred embodiment of the present invention, an image forming system comprises:

an image forming device;

a post-processing device comprising a sheet ejection tray; and

an operating section to select either a producing mode for prioritizing a productivity of an image forming or a loading mode for prioritizing a loading accuracy of printing sheets, wherein

the producing mode and the loading mode are operation modes for a series of operation from the image forming performed by the image forming device until a loading of the printing sheets for which the image forming is performed, on the sheet ejection tray by the post-processing device.

According to the image forming system, a user can operate the system so that the user can prioritize either the productivity or the matching accuracy in accordance with the intention of the user.

Preferably, the image forming system further comprises a control section to control an image forming operation of the image forming device so as to change an interval of the image forming, in accordance with one of the operation modes, which is selected by the operating section.

According to the image forming system, when the producing mode is selected, a number of images can be formed in a short time by decreasing the image forming intervals. Thus the productivity can be increased. On the other hand, when the loading mode is selected, the matching time can be ensured by increasing the image forming intervals. Thus the matching accuracy can be increased.

Preferably, when the loading mode is selected, the control section controls the image forming operation of the image forming device so that the interval of the image forming in the loading mode is longer than the interval of the image forming in the producing mode.

According to the image forming system, the matching time is ensured so that the matching can be performed in a neat manner. Thus, the matching accuracy can be prioritized in the series of operation.

Preferably, the image forming system further comprises:

a matching section to match edges of the printing sheets ejected on the sheet ejection tray; and

a control section to control a matching operation of the matching section so as to change a degree of matching of the edges of the printing sheets, in accordance with one of the operation modes, which is selected by the operating section.

Preferably, the matching section comprises a pair of matching plates to match the edges of the printing sheets by opening and closing the pair of matching plates, and

the control section controls at least one of an opening and closing time of the matching plates, the number of times the matching plates are opened and closed, and a closing position of the matching plates.

According to the image forming system, by adjusting the opening and closing time, the number of opening and closing, and the position of the matching plates, and in the producing mode, by decreasing the matching degree so that the image forming can be performed in a high speed, the productivity can be increased. In the loading mode, the matching accuracy can be increased by increasing the matching degree.

Preferably, when the loading mode is selected, the control section controls the number of times the matching plates are closed in the loading mode so as to be more than the number of times the matching plates are closed in the producing mode.

According to the image forming system, in the loading mode, the number of closing of the matching plates is increased so that the matching degree is increased. Thus, the matching accuracy is increased.

Preferably, the image forming system further comprises:

an intermediate conveying device to convey the printing sheets ejected from the image forming device to the post-processing device, the intermediate conveying device being provided in between the image forming device and the post-processing device; and

a control section to control a conveying operation for conveying the printing sheets by the intermediate conveying device, in accordance with one of the operation modes, which is selected by the operating section.

Preferably, the control section controls at least one of a conveying speed of the printing sheets by the intermediate conveying device, execution/non-execution of an overlapping in which the printing sheets are ejected so as to be overlapped, and the number of the printing sheets to be overlapped.

According to the image forming system, the conveying speed, whether or not the overlapping is performed, and the number of sheets to be overlapped in the intermediate conveying device can be adjusted. Thus the image forming can be performed in a high speed in the producing mode, or the matching accuracy is increased in the loading mode.

Preferably, when the loading mode is selected, the control section does not execute the overlapping of the printing sheets, and conveys the printing sheets per one printing sheet.

According to the image forming system, in the loading mode, the matching in a state of being one sheet each is possible by conveying the printing paper one sheet each. Thus the matching accuracy is increased.

According to a second aspect of the present invention, an image forming device comprises:

an image forming section;

a sheet ejection tray; and

an operating section to select either a producing mode for prioritizing a productivity of an image forming or a loading mode for prioritizing a loading accuracy of printing sheets, wherein

the producing mode and the loading mode are operation modes for a series of operation from the image forming performed by the image forming section until a loading of the printing sheets for which the image forming is performed, on the sheet ejection tray.

According to the image forming device, the user can operate the device so that the user can prioritize either the productivity or the matching accuracy in accordance with the intention of the user.

Preferably, the image forming device further comprises a control section to control an image forming operation of the image forming section so as to change an interval of the image forming, in accordance with one of the operation modes, which is selected by the operating section.

According to the image forming device, when the producing mode is selected, a number of images can be formed in a short time by decreasing the image forming intervals. Thus the productivity can be increased. On the other hand, when the loading mode is selected, the matching time can be ensured by increasing the image forming intervals. Thus the matching accuracy can be increased.

Preferably, when the loading mode is selected, the control section controls the image forming operation of the image forming section so that the interval of the image forming in the loading mode is longer than the interval of the image forming in the producing mode.

According to the image forming device, the matching time is ensured so that the matching can be performed in a neat manner. Thus, the matching accuracy can be prioritized in the series of operation.

Preferably, the image forming device further comprises:

a matching section to match edges of the printing sheets loaded on the sheet ejection tray; and

a control section to control a matching operation of the printing sheets loaded on the sheet ejection tray of the matching section so as to change a degree of matching of the edges of the printing sheets, in accordance with one of the operation modes, which is selected by the operating section.

Preferably, the matching section comprises a pair of matching plates to match the edges of the printing sheets by opening and closing the pair of matching plates, and

the control section controls at least one of an opening and closing time of the matching plates, the number of times the matching plates are opened and closed, and a position of the matching plates.

According to the image forming device, by adjusting the opening and closing time, the number of opening and closing, and the position of the matching plates, and in the producing mode, by decreasing the matching degree so that the image forming can be performed in a high speed, the productivity can be increased. In the loading mode, the matching accuracy can be increased by increasing the matching degree.

Preferably, when the loading mode is selected, the control section controls the number of times the matching plates are closed in the loading mode so as to be more than the number of times the matching plates are closed in the producing mode.

According to the image forming device, in the loading mode, the number of closing of the matching plates is increased so that the matching degree is increased. Thus, the matching accuracy is increased.

According to the third aspect, a post-processing device comprises:

a sheet ejection tray; and

a control section which corresponds to a producing mode for prioritizing a productivity of an image forming and a loading mode for prioritizing a loading accuracy of printing sheets, wherein

the producing mode and the loading mode are operation modes for a series of operation of a loading of the printing sheets for which the image forming is performed, on the sheet ejection tray.

According to the post-processing device, a user can operate the system so that the user can prioritize either the productivity or the matching accuracy in accordance with the intention of the user.

Preferably, the post-processing device further comprises:

a matching section to match edges of the printing sheets loaded on the sheet ejection tray; and

a control section to control a matching operation of the matching section so as to change a degree of matching of the edges of the printing sheets, in accordance with one of the operation modes.

Preferably, the matching section comprises a pair of matching plates to match the edges of the printing sheets by opening and closing the pair of matching plates, and

the control section controls at least one of an opening and closing time of the matching plates, the number of times the matching plates are opened and closed, and a closing position of the matching plates.

According to the post-processing device, by adjusting the opening and closing time, the number of opening and closing, and the position of the matching plates, and in the producing mode, by decreasing the matching degree so that the image forming can be performed in a high speed, the productivity can be increased. In the loading mode, the matching accuracy can be increased by increasing the matching degree.

Preferably, when the loading mode is selected, the control section controls the number of times the matching plates are closed in the loading mode so as to be more than the number of times the matching plates are closed in the producing mode.

According to the post-processing device, in the loading mode, the number of closing of the matching plates is increased so that the matching degree is increased. Thus, the matching accuracy is increased.

The present U.S. patent application claims a priority under the Paris Convention of Japanese patent application No. 2007-221207 filed on Aug. 28, 2007, which shall be a basis of correction of an incorrect translation.

What is claimed is:

1. An image forming system comprising:
an image forming device;
a post-processing device comprising a sheet ejection tray; and
an operating section to select either a producing mode for prioritizing a productivity of an image forming or a loading mode for prioritizing a loading accuracy of printing sheets, wherein
the producing mode and the loading mode are operation modes for a series of operation from the image forming performed by the image forming device until a loading of the printing sheets for which the image forming is performed, on the sheet ejection tray by the post-processing device.

2. The image forming system of claim 1, further comprising a control section to control an image forming operation of the image forming device so as to change an interval of the image forming, in accordance with one of the operation modes, which is selected by the operating section.

3. The image forming system of claim 2, wherein when the loading mode is selected, the control section controls the image forming operation of the image forming device so that the interval of the image forming in the loading mode is longer than the interval of the image forming in the producing mode.

4. The image forming system of claim 1, further comprising:
a matching section to match edges of the printing sheets ejected on the sheet ejection tray; and
a control section to control a matching operation of the matching section so as to change a degree of matching of the edges of the printing sheets, in accordance with one of the operation modes, which is selected by the operating section.

5. The image forming system of claim 4, wherein the matching section comprises a pair of matching plates to match the edges of the printing sheets by opening and closing the pair of matching plates, and
the control section controls at least one of an opening and closing time of the matching plates, the number of times the matching plates are opened and closed, and a closing position of the matching plates.

6. The image forming system of claim 5, wherein when the loading mode is selected, the control section controls the number of times the matching plates are closed in the loading mode so as to be more than the number of times the matching plates are closed in the producing mode.

7. The image forming system of claim 1, further comprising:
an intermediate conveying device to convey the printing sheets ejected from the image forming device to the post-processing device, the intermediate conveying device being provided in between the image forming device and the post-processing device; and
a control section to control a conveying operation for conveying the printing sheets by the intermediate conveying device, in accordance with one of the operation modes, which is selected by the operating section.

8. The image forming system of claim 7, wherein the control section controls at least one of a conveying speed of the printing sheets by the intermediate conveying device, execution/non-execution of an overlapping in which the printing sheets are ejected so as to be overlapped, and the number of the printing sheets to be overlapped.

9. The image forming system of claim 8, wherein when the loading mode is selected, the control section does not execute the overlapping of the printing sheets, and conveys the printing sheets per one printing sheet.

10. An image forming device comprising:
an image forming section;
a sheet ejection tray; and
an operating section to select either a producing mode for prioritizing a productivity of an image forming or a loading mode for prioritizing a loading accuracy of printing sheets, wherein
the producing mode and the loading mode are operation modes for a series of operation from the image forming performed by the image forming section until a loading of the printing sheets for which the image forming is performed, on the sheet ejection tray.

11. The image forming device of claim 10, further comprising a control section to control an image forming operation of the image forming section so as to change an interval of the image forming, in accordance with one of the operation modes, which is selected by the operating section.

12. The image forming device of claim 11, wherein when the loading mode is selected, the control section controls the image forming operation of the image forming section so that the interval of the image forming in the loading mode is longer than the interval of the image forming in the producing mode.

13. The image forming device of claim 10, further comprising:
a matching section to match edges of the printing sheets loaded on the sheet ejection tray; and
a control section to control a matching operation of the printing sheets loaded on the sheet ejection tray of the matching section so as to change a degree of matching of the edges of the printing sheets, in accordance with one of the operation modes, which is selected by the operating section.

14. The image forming device of claim 13, wherein the matching section comprises a pair of matching plates to match the edges of the printing sheets by opening and closing the pair of matching plates, and
the control section controls at least one of an opening and closing time of the matching plates, the number of times the matching plates are opened and closed, and a position of the matching plates.

15. The image forming device of claim 14, wherein when the loading mode is selected, the control section controls the number of times the matching plates are closed in the loading mode so as to be more than the number of times the matching plates are closed in the producing mode.

16. A post-processing device comprising:
a sheet ejection tray; and
a control section which corresponds to a producing mode for prioritizing a productivity of an image forming and a loading mode for prioritizing a loading accuracy of printing sheets, wherein
the producing mode and the loading mode are operation modes for a series of operation of a loading of the printing sheets for which the image forming is performed, on the sheet ejection tray.

17. The post-processing device of claim 16, further comprising:
a matching section to match edges of the printing sheets loaded on the sheet ejection tray; and
a control section to control a matching operation of the matching section so as to change a degree of matching of the edges of the printing sheets, in accordance with one of the operation modes.

18. The post-processing device of claim 17, wherein the matching section comprises a pair of matching plates to match the edges of the printing sheets by opening and closing the pair of matching plates, and
the control section controls at least one of an opening and closing time of the matching plates, the number of times the matching plates are opened and closed, and a closing position of the matching plates.

19. The post-processing device of claim 18, wherein when the loading mode is selected, the control section controls the number of times the matching plates are closed in the loading mode so as to be more than the number of times the matching plates are closed in the producing mode.
